(19) United States
(12) Patent Application Publication
(10) Pub. No.: US 2008/0096487 A1
(43) Pub. Date: Apr. 24, 2008

(54) Radio communication apparatus and radio communication method

(76) Inventor: Toshiyuki Masaki, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/643,913

(22) Filed: Dec. 22, 2006

(30) Foreign Application Priority Data
Dec. 26, 2005 (JP) 2005-373141

(51) Int. Cl. H04B 17/00

(52) U.S. Cl. 455/67.11

(57) ABSTRACT

According to one embodiment, a radio communication apparatus with an antenna to be used for connecting to base stations comprises a radio communication unit which performing radio communications with the base stations through the antenna, a position information acquiring unit which acquires position information relating to a current position of the radio communication apparatus, a database which stores a plurality of items of base station information relating to positions of base stations wirelessly connectable by the radio communication unit, and a control unit which retrieves the base station information relating to a base station related to the position information acquired by the position information acquiring unit to control directivity of the antenna of the radio communication apparatus on the basis of the position information and the base station information.

### CROSS-REFERENCE TO RELATED APPLICATIONS

This application is based upon and claims the benefit of priority from Japanese Patent Application No. 2005-373141, filed Dec. 26, 2005, the entire contents of which are incorporated herein by reference.

### BACKGROUND

1. Field

One embodiment of the invention relates to a radio communication apparatus and a radio communication method.

2. Description of the Related Art

To establish communications among radio communication apparatuses, antennas have been used, and communication apparatuses capable of revising the directivity of the antennas have been proposed. For example, Jpn. Pat. Appln. KOKAI Publication No. 2002-330094 discloses a radio station which can efficiently transmit a control signal as well as can prevent an increase in interference in any case of making a communication with a specific radio station and of making a communication with an unspecified radio station by revising the directivity of an antenna.

### BRIEF DESCRIPTION OF THE SEVERAL VIEWS OF THE DRAWINGS

A general architecture that implements the various features of the invention will now be described with reference to the drawings. The drawings and the associated description are provided to illustrate embodiments of the invention and not to limit the scope of the invention.

FIG. 1 is an exemplary block diagram illustrating a configuration of a radio communication apparatus regarding one embodiment of the present invention;

FIGS. 2A and 2B are exemplary views illustrating one example of a database 10 shown in FIG. 1;

FIG. 3 is an exemplary view for explaining a concrete method of controlling a phase of an electric wave input to an antenna;

FIG. 4 is an exemplary flowchart for explaining an operation of the radio communication apparatus of the present embodiment; and

FIG. 5 is an exemplary flowchart for explaining an operation of a radio communication apparatus of a modified example.

### DETAILED DESCRIPTION

Various embodiments according to the invention will be described hereinafter with reference to the accompanying drawings. In general, according to one embodiment of the invention, a radio communication apparatus with an antenna to be used for connecting to base stations, comprises a radio communication unit which perform radio communications with the base stations through the antenna, a position information acquiring unit which acquires position information that is a current position of the radio communication apparatus, a database which stores a plurality of items of base station information relating to positions of base stations wirelessly connectable by the radio communication unit, and a control unit which retrieves the base station information relating to base stations related to the position information acquired by the position information acquiring unit from the database and controls directivity of the antenna of the radio communication apparatus on the basis of the position information and the base station information.

### FIRST EMBODIMENT

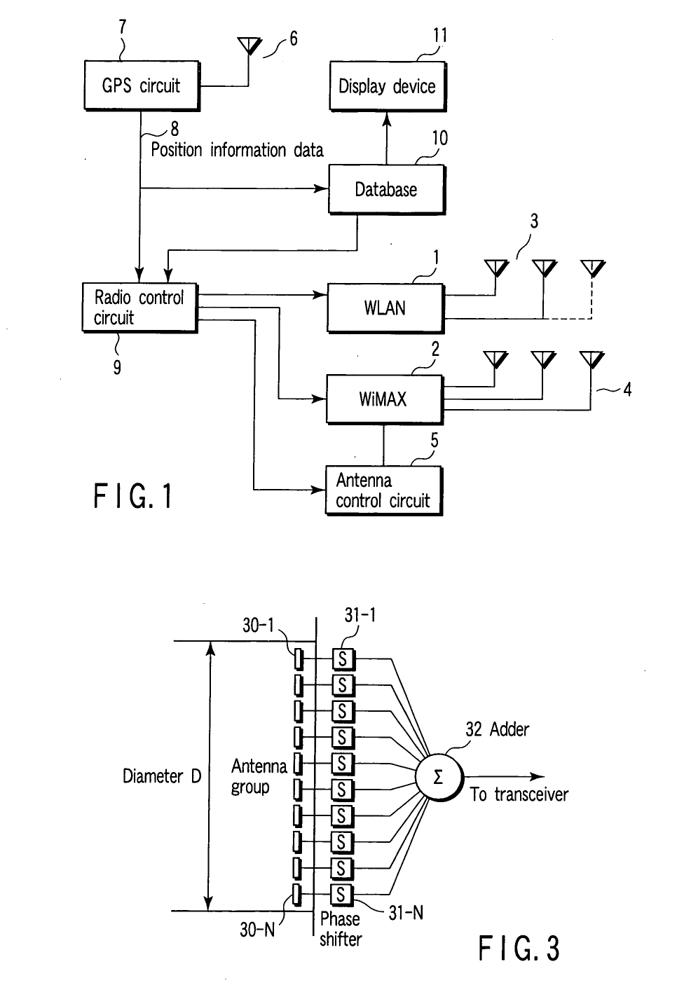

FIG. 1 is a block diagram showing a configuration of a radio communication apparatus regarding one embodiment of the present invention. As shown in FIG. 1, the radio communication apparatus of the embodiment is composed of a wireless LAN (hereinafter, referred to as WLAN) circuit 1 and a WiMAX(World Interoperability for Microwave Access) circuit 2. An antenna for WLAN 3 consisting of a plurality of antenna elements is connected to the WLAN circuit 1, and an antenna for WiMAX 4 consisting of a plurality of antenna elements is connected to a WiMAX circuit 2. As for types of the antennas 3 and 4, a variable directivity antenna, such as a phased array antenna, an adaptive antenna, and a smart antenna are available.

An antenna control circuit 5 to control a phase of an electric wave input to the plurality of antenna elements so as to control the directivity of the antenna 4 is connected.

In contrast to the wireless LAN, which is a communication standard to achieve a radio communication in a home, the WiMAX is a communication standard to make a high-rate radio communication by widening a communication distance up to a metropolitan area.

On the other hand, radio signals received from a plurality of global positioning system (GPS) satellites by means of a GPS antenna 6 are input to a GPS circuit 7. The GPS circuit 7 performs a prescribed computing for the input signal to acquire and output position information. A radio control circuit 9 generates the control signal to control the WLAN circuit 1, WiMAX circuit 2, and further the antenna control circuit 5 on the basis of the position information. The radio control circuit 9 retrieves information relating to base stations stored in a database 10 on the basis of the position information. A display device 11 is a part to display the retrieval result from the database 10. The display device 11, for instance, displays network names, position information of the base stations each belonging to the networks, communication rates, etc.

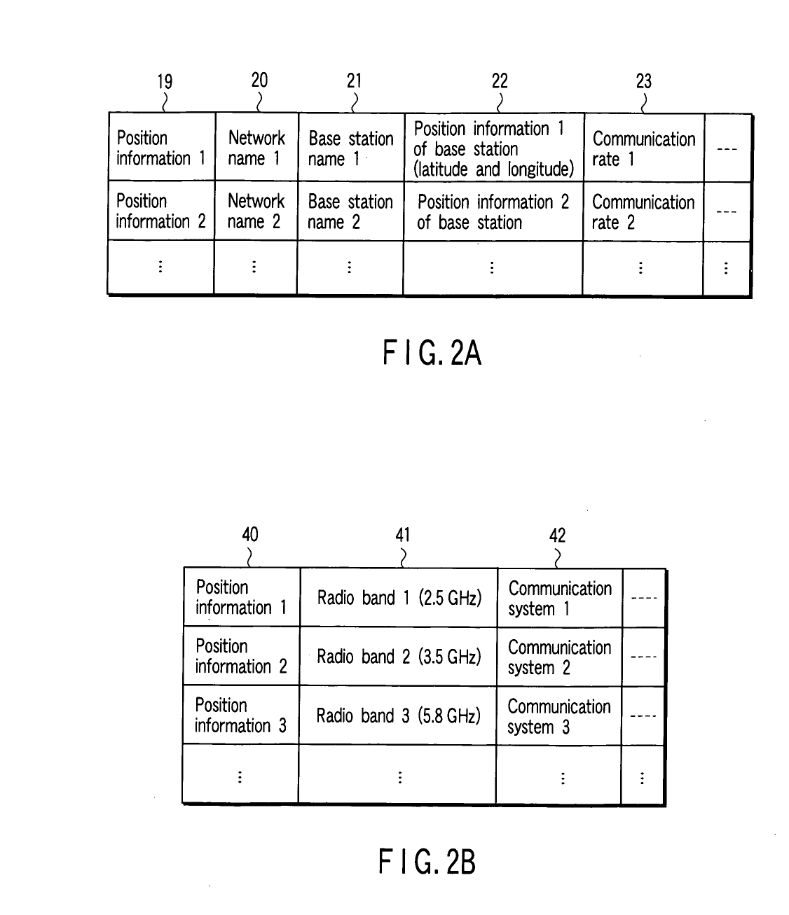

FIG. 2A is a view showing one example of the database 10 shown in FIG. 1, in relation to position information 19 of the radio communication apparatus, the database 10 has stored, for example, network names 20, base station names 21, position information (latitude, longitude) of base stations 22, communication rates 23, etc. With the information relating to the positions of the base stations shown in FIG. 2A stored in the radio communication apparatus, it becomes possible to control the directivity of the antenna by calculating distances from the self station (radio communication apparatus) to the base stations and angles to the base stations and to estimate the communication rate. For the data (time, latitude, longitude, height), an NMEA format that is a GPS international standard is employed generally. The database 10 can make a change therein and an addition thereto.

FIG. 2B is a view depicting other example of the database 10, and in relation to position information 40 of the radio communication apparatus, it stores, for example, radio bands 41, communication systems 42, etc. Here, a radio band 1 (2.5 GHz zone), a radio band 2 (3.5 GHz zone), and a radio band 3 (5.8 GHz zone) show examples of radio bands in each country proposed in the WiMAX.

Hereinafter, a specific method for controlling the phase of the electric wave input to the antenna will be put forth by referring to FIG. 3. A phased array antenna is, as shown in FIG. 3, composed of a plurality of antenna elements 30-1 to 30-N consisting of an antenna group. Each antenna element 30-1 to 30-N being arranged at prescribed intervals, phases of electric waves input to each antenna element 30-1 to 30-N are different from one another. Phase shifters 31-1 to 31-N can electrically vary phases of each electric wave input to each antenna element 30-1 to 30-N arbitrarily. Therefore, adding through an adder 32 the electric waves arrived from directions of base stations all phases of each electric wave from which are precisely overlapped enables obtaining the largest power output. Electric waves from the other directions are cancelled out with one another. The way of giving added weight of phases in the phase shifters 31-1 to 31-N allows revising the directivity of the antenna. The above-mentioned explanation having done about the reception of the electric waves, with the directivity of the antenna similarly controlled also in the case of a transmission, the radio communication apparatus can emit electric waves in any direction.

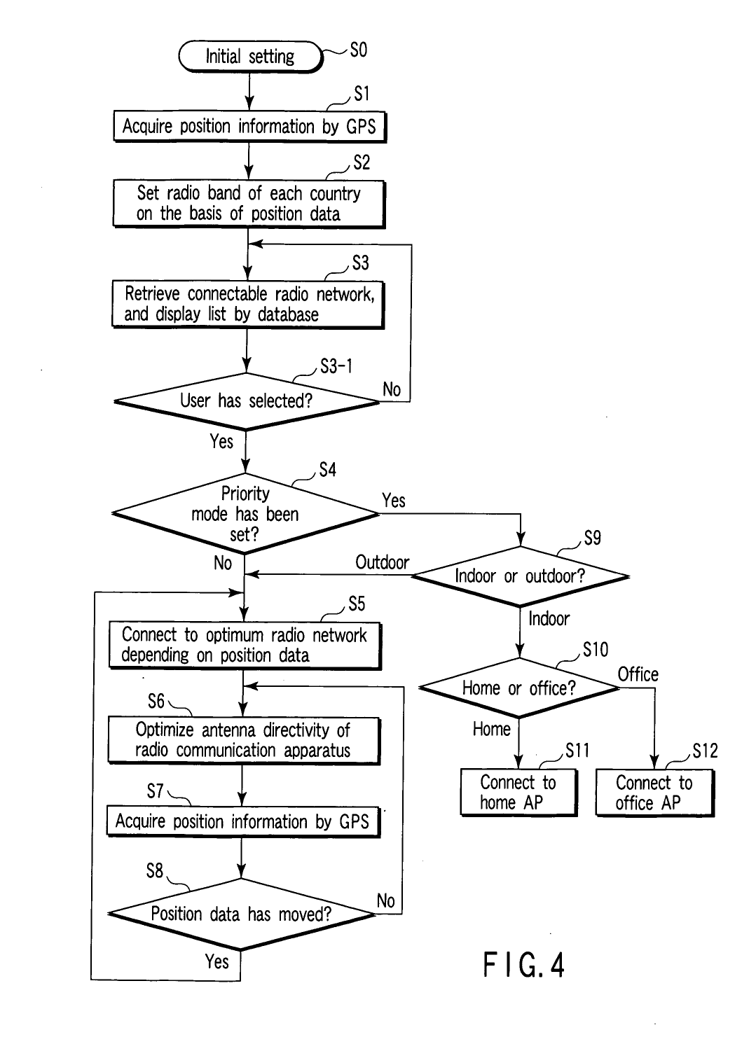

FIG. 4 is a flowchart for explaining operations of the radio communication apparatus of the present embodiment. At first, for initial setting, in the communication apparatus, a priority mode, etc., is set by a user. As to concrete examples of priority mode setting, any of setting whether the wireless LAN or the WIMAX, whether indoor or outdoor, and the like are possible setting.

Next, the GPS circuit 7 acquires position information of the communication apparatus (step S1). Then, depending on the acquired position information, the communication apparatus retrieves information relating to the radio standards (radio band, communication system, etc.) of each country stored in the database 10 to set the WiMAX circuit 2 and antenna 4 for WiMAX, or the WLAN circuit 1 and antenna for the WLAN 3 to the radio standard of the country to which the position information belongs (step S2). For instance, in the WiMAX, as shown in FIG. 2B, the 2.5 GHz zone, 3.5 GHz zone and 5.8 GHz zone being considered as for radio bands for each country, arbitrary radio bands selected from those zones may be set for the radio bands, respectively.

Next to this, the communication apparatus refers to the database 10 on the basis of the acquired position information to retrieve a list of connectable radio networks (and their base stations) and each communication rates to be each estimated, and displays them on the display device 11 to present them to the user (step S3). As for the retrieval range in this retrieval, retrieval only for a prescribed range, without retrieving the whole contents of the database 10 is possible approach. For instance, the transmission distance in the WiMAX is set to 50 km as maximum as a specification, but a range of 5-8 km is considered practically. Therefore, the communication apparatus may retrieve base station positions in a range of, for example, plus or minus 10 km from the position (X0, Y0) that is the communication apparatus, respectively.

In succession, the communication apparatus confirms that the user has selected the desired network and communication rate by referring to the displayed list (step S3-1). The communication apparatus then determines whether the priority mode has been set or not by the user (step S4). Here, in the case of NO, the communication apparatus shifts to a step S5, and in the case of YES, it confirms the content of the mode setting. Namely, at first, the communication apparatus determines whether it is located “indoors” or “outdoors” (step S9). Here, with position information of, for example, a home of one's own or an office previously stored, the communication apparatus can determine if the current position of the communication apparatus coincides with the stored position information, it is located indoors, and that if the communication apparatus dislocates on a large scale, it is located outdoors.

If the determination result shows “outdoor”, the communication apparatus shifts to a step S5, and if the result shows “indoor”, then, it determines whether the communication apparatus is located at “home of one's own” or at “office” (step S10). If the determination result shows “office”, the access point (AP) of the office is connected as a network connecting destination (step S12). If the determination result shows “home of one's own”, the AP of the home of one's own is connected as the network connecting destination (step S11).

When the communication apparatus is located indoors, the AP of the one's home or office to be connected is wirelessly connected via the WLAN. That is, the communication apparatus makes a radio communication by using the WLAN circuit 1 and the antenna for the WLAN 3.

On the contrary, when the priority mode has not been set in the step S4, or when the determination in the step S9 shows “outdoor”, the communication apparatus advances to the step S5. Here, the optimum radio network selected by the user and its base station in the step S3-1 are connected to the communication apparatus (step S5). Next, the communication apparatus decides a direction on the basis of the positional relationship between the connected radio network and the base station to control the directivity of the antenna for the WIMAX 4 optimally (step S6).

Namely, if the communication apparatus is located outdoors, it is wirelessly connected through the WiMAX. That is, the communication apparatus uses the WiMAX circuit 2 and the WiMAX antenna 4 to make the radio communication.

Here, the communication apparatus acquires position information thereof again by means of the GPS circuit 7 (step S7) to determine whether or not the position information has moved (step S8). If the step S8 branches to NO, the communication apparatus returns to step S6, if it branches to YES, it retunes to the step S5.

The present embodiment determining whether the radio communication apparatus presents indoors or outdoors on the basis of the position information of the radio communication apparatus, it may determines on the basis of received power.

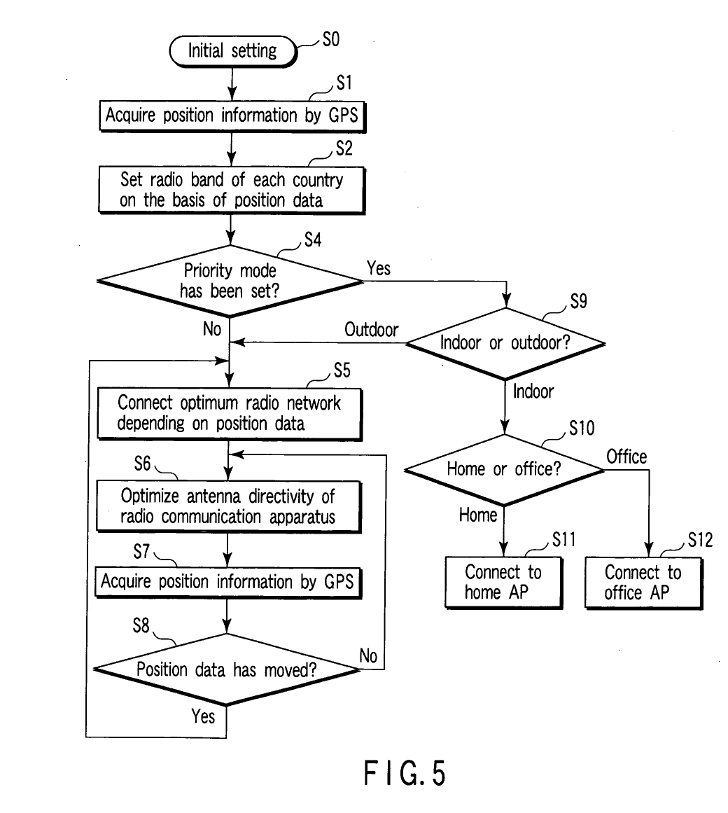

FIG. 5 is a flowchart for explaining operations of radio communication apparatus in a modified example.

The flowchart of FIG. 5 differs from that of FIG. 4 from the point that although the flow of FIG. 4 connects the communication apparatus to the optimum radio network on the basis of the setting by the user, the present modified embodiment is characterized in that the communication apparatus retrieves the connectable radio networks and base stations from the database 10 on the basis of the acquired position information to automatically connect the communication apparatus to the radio network and base station located at the nearest distance among them (step S6).

According to the aforementioned embodiment, the directivity of the antenna relating to the base station being controlled optimally, the radio communication apparatus improves communication quality, shortens a communicating time, and also it can improve a property of following to a high-rate movement.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication apparatus with an antenna to be used for connecting to base stations, comprising:
a radio communication unit which perform radio communications with the base stations through the antenna;
a position information acquiring unit which acquires position information that is a current position of the radio communication apparatus;
a database which stores a plurality of items of base station information relating to positions of base stations wirelessly connectable by the radio communication unit; and
a control unit which retrieves the base station information relating to base stations related to the position information acquired by the position information acquiring unit from the database and controls directivity of the antenna of the radio communication apparatus on the basis of the position information and the base station information.

2. The radio communication apparatus according to claim 1, wherein the control unit retrieves only base stations belonging to a prescribed range around a position acquired by the position information acquiring unit.

3. The radio communication apparatus according to claim 1, wherein
the database stores names of connectable networks and communication rates to be estimated; and
the control unit retrieves the names of connectable networks and communication rates to be estimated which are related to the position information acquired by the position information acquiring unit to present them to a presentation unit.

4. The radio communication apparatus according to claim 1, wherein
the database stores information relating to radio standards of each country; and
the control unit retrieves a radio standard of a region relating to position information acquired by the position information acquiring unit to set the radio communication unit and the antenna to the radio standard.

5. The radio communication apparatus according to claim 1, wherein
the data base stores information whether the radio communication apparatus is located indoors or outdoors; and
the control unit determines whether the radio communication apparatus is located indoors or outdoors on the basis of the position information acquired by the position information acquiring unit to set a connecting destination.

6. A radio communication method using a radio communication apparatus with an antenna to be used for connecting to base stations, comprising
acquiring position information of a current position of the radio communication apparatus; and
controlling directivity of the antenna of the radio communication apparatus on the basis of the position information and base station information by retrieving a base station related to the position information acquired in the acquiring of the position information from a database with the base station information relating to a position of a base station connectable by the antenna stored therein.

7. The radio communication method according to claim 6, wherein the controlling retrieves only base stations belonging to a prescribed range around the position acquired in the acquiring of the position information.

8. The radio communication method according to claim 6, wherein
the database stores names of connectable networks and communication rates to be estimated; and
the controlling retrieves names of connectable networks and communication rates to be estimated which are related to the position information acquired in the acquiring of the position information to present them to a presentation unit.

9. The radio communication method according to claim 6, wherein
the database stores information relating to radio standards of each country; and
the controlling retrieves a radio standard of a country relating to the position information acquired in the acquiring of the position information to set a radio communication unit performing radio communications with the base stations by means of the antenna and the antenna to the radio standard.

10. The radio communication method according to claim 6, wherein
the database stores information whether the radio communication apparatus is located indoor or outdoors; and
the controlling determines whether the radio communication apparatus is located indoors or outdoors on the basis of the position information acquired in the acquiring of the position information to set a connecting destination.
